(19) United States
(12) Patent Application Publication
(10) Pub. No.: US 2023/0267282 A1
(43) Pub. Date: Aug. 24, 2023

(54) POETRY GENERATION

(71) Applicant: BEIJING SOGOU TECHNOLOGY DEVELOPMENT CO., LTD., Beijing (CN)

(72) Inventors: Baokui GUO, Beijing (CN); Qi KANG, Beijing (CN)

(73) Assignee: BEIJING SOGOU TECHNOLOGY DEVELOPMENT CO., LTD., Beijing (CN)

(21) Appl. No.: 18/140,500

(22) Filed: Apr. 27, 2023

Related U.S. Application Data
(63) Continuation of application No. PCT/CN2021/102185, filed on Jun. 24, 2021.

(30) Foreign Application Priority Data
Jan. 29, 2021 (CN) 202110130829.3

(51) Int. Cl. G06F 40/40; G06F 40/103; G06N 3/08

(52) U.S. Cl. CPC G06F 40/40; G06F 40/103; G06N 3/08

(57) ABSTRACT

A method for poetry generation includes receiving generation information indicative of a theme for the poetry generation, and determining at least a candidate piece of poetry corresponding to the generation information according to an autoregressive language model that is configured to generate elements in the candidate piece of poetry in an autoregressive manner with a plurality of regression rounds. An element in the elements is a character or a word. The autoregressive language model is configured for generating poetry in a plurality of formats, the autoregressive language model includes a plurality of processing layers connected sequentially, a processing layer in the plurality of processing layers is configured to determine attention levels for potential elements in a potential element list according to generated elements prior to a current regression round, and predict one or more additional element for the current regression round using a neural network according to the attention levels.

### RELATED APPLICATIONS

The present application is a continuation of International Application No. PCT/CN2021/102185, entitled “POEM GENERATION METHOD AND APPARATUS, AND MEDIUM” and filed on Jun. 24, 2021, which claims priority to Chinese Patent Application No. 202110130829.3, entitled “METHOD AND APPARATUS FOR GENERATING POEM OR CI-POEM, AND MEDIUM” and filed on Jan. 29, 2021. The entire disclosures of the prior applications are hereby incorporated by reference in their entirety.

### FIELD OF THE TECHNOLOGY

Embodiments of this disclosure relate to the technical field of computers, including poetry generation.

### BACKGROUND OF THE DISCLOSURE

Poems or ci-poems refer to poetry represented by ancient style poems, modern style poems and metrical ci-poems. Poems or ci-poems are the literature and art of expounding the mind, while poets and ci poets need to master mature artistic skills and, according to strict rhythm requirements, use concise language, dense organization, abundant emotion and rich images to highly concentrate on the expression of social life and human spiritual world.

In practical applications, users have a need of generating poems or ci-poems. The poems or ci-poems generated by users can be sent to relatives and friends as blessing words to express greetings. Alternatively, the generated poems or ci-poems can be published in the circle of friends to improve the quality of published content.

### SUMMARY

Embodiments of this disclosure provide methods and apparatuses for generating poetry. A device for generating poetry can generate candidate pieces of poetry (e.g., poems or ci-poems) that follow the rules of poetry, and can improve the consistency of the generated candidate pieces of poetry.

Some aspects of the disclosure provide a method for poetry generation. The method includes receiving generation information indicative of a theme for the poetry generation, and determining at least a candidate piece of poetry corresponding to the generation information according to an autoregressive language model. The autoregressive language model is configured to generate elements in the candidate piece of poetry in an autoregressive manner with a plurality of regression rounds. An element in the elements is a character or a word. The autoregressive language model is configured for generating poetry in a plurality of formats, the autoregressive language model includes a plurality of processing layers connected sequentially, a processing layer in the plurality of processing layers is configured to determine attention levels for potential elements in a potential element list according to generated elements prior to a current regression round, and predict one or more additional element for the current regression round using a neural network according to the attention levels.

Some aspects of the disclosure provide an apparatus for poetry generation. The apparatus includes processing circuitry configured to receive generation information indicative of a theme for the poetry generation, and determine at least a candidate piece of poetry corresponding to the generation information according to an autoregressive language model that is configured to generate elements in the candidate piece of poetry in an autoregressive manner with a plurality of regression rounds. An element in the elements is a character or a word.

The autoregressive language model is configured to generate poetry in a plurality of formats, the autoregressive language model includes a plurality of processing layers connected sequentially, a processing layer in the plurality of processing layers is configured to determine attention levels for potential elements in a potential element list according to generated elements prior to a current regression round, and predict one or more additional element for the current regression round using a neural network according to the attention levels.

Some aspects of the disclosure provide a non-transitory computer-readable storage medium storing instructions which when executed by at least one processor cause the at least one processor to perform the method for poetry generation.

Embodiments of this disclosure may include the following advantages:

The embodiments of this disclosure obtain a language model through training according to a poetry corpus, and can learn the rules of poetry, such as the rules of rhymes, tonal patterns and antithesis forms of poetry, such as five-character and seven-character poems, quatrains and metrical poems, into the parameters of the language model. In this way, the language model can follow the rules of poetry in the process of generating poetry, thus generating candidate pieces of poetry (e.g., poems or ci-poems) that follow the rules of poetry.

In addition, the language model in the embodiments of this disclosure adopts an autoregression mechanism, which can update the input information according to a real-time prediction result, so that a text with a preset length can be generated iteratively.

Besides, the self-attention module of the language model in the embodiments of this disclosure can quickly capture the dependency between each known element such as a character or word, and the character or word in the character or word list (also referred to as element list), so it can take the characters or words with strong dependency as a prediction result, thus improving the consistency of the generated candidate pieces of poetry.

### BRIEF DESCRIPTION OF THE DRAWINGS

To describe the technical solutions in embodiments of this disclosure more clearly, the following briefly describes the accompanying drawings required for describing the embodiments of this disclosure. The accompanying drawings in the following description show merely some embodiments of this disclosure.

FIG. 1 is a schematic diagram of an application environment of a method for generating a poem or ci-poem according to an embodiment of this disclosure.

FIG. 2 is a flowchart of steps of a method for generating a poem or ci-poem according to an embodiment of this disclosure.

FIG. 3 is a structural block diagram of an apparatus for generating a poem or ci-poem according to an embodiment of this disclosure.

FIG. 4 is a block diagram of a device 800 for generating a poem or ci-poem according to an embodiment of this disclosure.

FIG. 5 is a schematic structural diagram of a server according to an embodiment of this disclosure.

### DESCRIPTION OF EMBODIMENTS

The following describes technical solutions in the embodiments of this disclosure with reference to the accompanying drawings. The described embodiments are some embodiments of this disclosure rather than all of the embodiments. Other embodiments obtained based on the embodiments of this disclosure shall fall within the scope of protection of this disclosure.

An embodiment of this disclosure provides a scheme for generating a piece of poetry (e.g., a poem or ci-poem), which is used for providing poem or ci-poem generation services.

The scheme specifically includes: receiving generation information; and determining at least one candidate poem or ci-poem corresponding to the generation information according to an autoregressive language model. The language model is obtained through training according to a poem or ci-poem corpus, and is configured to predict unknown information of a poem or ci-poem in unit of character or word according to known information of the poem or ci-poem. The language model specifically includes a plurality of processing layers connected sequentially. Each of the processing layers specifically includes a self-attention module and a neural network module. The self-attention module is configured to determine attention information from a known character or word in a poem or ci-poem sentence to a character or word in a character or word list, so as to predict unknown characters or words in the poem or ci-poem sentence according to the attention information.

In the embodiment of this disclosure, the generation information may carry information required for poem or ci-poem generation. The embodiment of this disclosure determines at least one candidate poem or ci-poem corresponding to the generation information according to the autoregressive language model.

The language model is an abstract mathematical model of language according to objective facts of language. The role of the language model may include predicting a next character or word according to known information of a sentence.

The autoregressive language model adopts an autoregression mechanism. The autoregression mechanism may be to update input information of the language model according to a prediction result (predicted characters or words). Specifically, a current-round prediction result is added after current-round input information to obtain next-round input information, and the next-round input information is inputted into the language model to obtain a next-round prediction result. Since the autoregressive language model can update the input information according to the real-time prediction result, it can iteratively generate a text with a preset length. The preset length may be within the range of a poem or ci-poem length.

The embodiments of this disclosure obtain a language model through training according to a poem or ci-poem corpus, and can learn the rules of poems and ci-poems, such as the rules of rhymes, tonal patterns and antithesis forms of poems and ci-poems, such as five-character and seven-character poems, quatrains and metrical poems, into the parameters of the language model. In this way, the language model can follow the rules of poems or ci-poems in the process of generating poems or ci-poems, thus generating candidate poems or ci-poems that follow the rules of poems or ci-poems.

Moreover, in terms of architecture, in the embodiment of this disclosure, the language model specifically includes a plurality of processing layers connected sequentially. Each of the processing layers specifically includes a self-attention module and a neural network module. The self-attention module is configured to determine attention information from a known character or word in a poem or ci-poem sentence to a character or word in a character or word list, so as to predict unknown characters or words in the poem or ci-poem sentence according to the attention information. The self-attention module determines attention from each known character or word to a character or word in a character or word list, that is, at a position of each known character or word, determines attention information corresponding to a character or word in a character or word list. In this way, the characters or words as the prediction result can be determined from the character or word list according to the attention information. The self-attention module of the language model can quickly capture the dependency between each known character or word and the character or word in the character or word list, so it can take the characters or words with strong dependency as a prediction result, thus improving the consistency of the generated candidate poems or ci-poems.

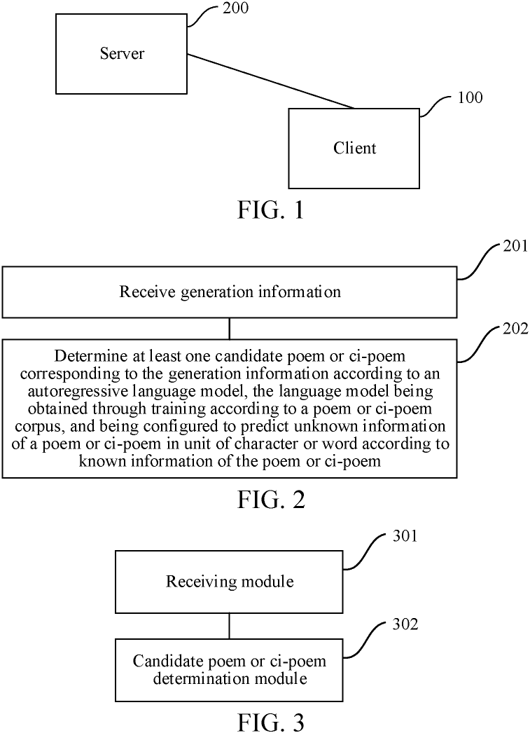

The method for generating a poem or ci-poem provided by the embodiment of this disclosure can be applied to an application environment illustrated in FIG. 1. As shown in FIG. 1, a client 100 and a server 200 are located in a wired or wireless network. Through the wired or wireless network, the client 100 and the server 200 perform data interaction.

In some examples, the client 100 may operate on a terminal. The terminal specifically includes, but is not limited to, a smart mobile phone, a tablet computer, an e-book reader, a Moving Picture Experts Group Audio Layer III (MP3) player, a Moving Picture Experts Group Audio Layer IV (MP4) player, a laptop portable computer, a vehicle-mounted computer, a desktop computer, a set-top box, a smart television, a wearable device, and the like. The client 100 may correspond to a website or an APP.

The client 100 may receive generation information inputted by a user, determine at least one candidate poem or ci-poem corresponding to the generation information according to an autoregressive language model, and display the at least one candidate poem or ci-poem to the user.

Alternatively, the client 100 may receive generation information inputted by a user, transmit the generation information to the server 200, and receive at least one candidate poem or ci-poem generated by the server 200 according to the generation information.

### Method Embodiment 1

In method embodiment 1, a language model is trained according to a poem or ci-poem corpus, so that the language model has the ability of generating poems or ci-poems.

The embodiments of this disclosure obtain a language model through training according to a poem or ci-poem corpus, and can learn the rules of poems and ci-poems, such as the rules of rhymes, tonal patterns and antithesis forms of poems and ci-poems, such as five-character and seven-character poems, quatrains and metrical poems, into the parameters of the language model. In this way, the language model can follow the rules of poems or ci-poems in the process of generating poems or ci-poems, thus generating candidate poems or ci-poems that follow the rules of poems or ci-poems.

The poem or ci-poem corpus may include poems with at least one format parameter. The format parameter may include at least one of sentence number parameter, character number parameter of characters contained in each sentence, and the like.

The sentence number parameter may include at least one of eight and four. According to the sentence number parameter, rhymed verses can be divided into metrical poems and quatrains. A metrical poem is a rhymed verse having eight sentences, and a quatrain is a rhymed verse having four sentences.

The character number parameter of characters contained in each sentence may include at least one of five, six and seven. According to the character number parameter of characters contained in each sentence, poems can be divided into seven-character poems and five-character poems. Each sentence of a seven-character poem is mainly composed of seven characters. It is not required that each sentence of a seven-character poem has seven characters, but that some sentences of a seven-character poem contain seven characters. A five-character poem is a kind of poetry having five characters in each sentence.

The sentence number parameter and the character number parameter may be combined. For example, five-character poems may include five-character metrical poems and five-character quatrains. Seven-character poems may include seven-character metrical poems and seven-character quatrains.

Ci-poem is a different form of poetry, and cipai is the name of the tune of the ci-poem, which may be used as the format parameter of the ci-poem. Different cipai have provisions on the total number of sentences, the number of sentences, the number of characters in each sentence and the tone.

It can be understood that the above rhymed verses or ci-poems are only examples of poems or ci-poems in the embodiment of this disclosure, and shall not be understood as limitations to poems or ci-poems in the embodiment of this disclosure.

In fact, in addition to the rhymed verses, the poems or ci-poems in the embodiment of this disclosure may further include miscellaneous poems. The types of miscellaneous poems may include: palindromic poems, strip poems, acrostic poems, pagoda poems, riddle poems, windlass poems, eight-tone song poems, poems in which the initial characters of the lines form a phrase, doggerel poems, humorous poems, collection poems, couplet poems, centennial poems, embedded character poems, broken string style poems, spiritual style poems, etc.

Moreover, in addition to Chinese poems or ci-poems, the poems or ci-poems in the embodiment of this disclosure may further include poems or ci-poems of other countries, such as sonnets. The format parameters of sonnets may include line number, rhyme, syllable, tone, structure, etc. It can be understood that the specific poems or ci-poems are not limited in the embodiment of this disclosure.

The embodiment of this disclosure may take a preset number of poems or ci-poems as the poem or ci-poem corpus, and use the poem or ci-poem corpus to perform unsupervised training on the language model, so that the trained language model has the ability of generating poems or ci-poems. Examples of the preset number may include 640,000, etc. It can be understood that the preset number of the poem or ci-poem corpus is not limited in the embodiment of this disclosure.

In the embodiment of this disclosure, languages corresponding to the poem or ci-poem corpus may include Chinese, English, German, Korean, Japanese, etc. It can be understood that the language model in the embodiment of this disclosure may be applied to any language.

The language model in the embodiment of this disclosure predicts unknown information of a poem or ci-poem in unit of character or word according to known information of the poem or ci-poem. The known information may include a known character or word of a poem or ci-poem sentence, or a poem or ci-poem theme and a known character or word of a poem or ci-poem sentence.

The character or word can represent a basic unit used for recording a language. A character or word may include a character or a word. Taking Chinese as an example, a character or word may include a character, that is, a Chinese poem or ci-poem may be generated in unit of character. Taking English as an example, a character or word may include a word, that is, an English poem may be generated in unit of word. For the generation of poems and ci-poems in other languages, a reference may be made.

In terms of architecture, in the embodiment of this disclosure, the language model specifically includes a plurality of processing layers connected sequentially. Each of the processing layers specifically includes a self-attention module and a neural network module. The self-attention module is configured to determine attention information from a known character or word in a poem or ci-poem sentence to a character or word in a character or word list, so as to predict unknown characters or words in the poem or ci-poem sentence according to neural network-related information such as the attention information.

The number of the processing layers may be determined by those skilled in the art according to actual application requirements. The range of the number of the processing layers may be [4, 24]. For example, in order to reduce computation, the number of the processing layers may be 4. It can be understood that the specific number of the processing layers is not limited in the embodiment of this disclosure.

The processing process of a first processing layer may include: receiving input information, processing the input information through the self-attention module, and then transmitting a processing result to the neural network module. After the first processing layer completes the processing, the output information is transmitted to a next processing layer for further computation. The processing method of different processing layers is the same, but each of the processing layers maintains parameters in its own self-attention module and neural network module.

After the output information is generated in the last processing layer, the language model may determine the attention information corresponding to the character or word in the character or word list according to the attention information included in the output information from the known character or word in the poem or ci-poem sentence to the character or word in the character or word list. Furthermore, according to the attention information corresponding to the character or word in the character or word list, characters or words as the prediction result may be determined from the character or word list. For example, in a case that the attention information corresponding to the character or word in the character or word list is attention score, characters or words as the prediction result may be determined from the character or word list according to the order of attention scores from high to low. For example, N characters or words with high attention scores (N is a natural number greater than 0) may be selected as a current-round prediction result.

The character or word list in the embodiment of this disclosure may be a character or word list of a preset size corresponding to a preset language. The preset language may be determined according to the language in which the poem or ci-poem is generated. For example, the preset language may be Chinese. The preset size can represent the number of characters or words included in the character or word list. Examples of the preset scale may include 10,896, etc. It can be understood that the specific size of the character or word list is not limited in the embodiment of this disclosure.

A common poem or ci-poem corpus may include poem or ci-poem sentences. In this way, the rules of poems or ci-poems, such as the rhymes, tonal patterns and antithesis forms of poems or ci-poems, such as five-character and seven-character poems, quatrains and metrical poems, can be learned into the parameters of the language model.

In an embodiment of this disclosure, the poem or ci-poem corpus may include poem or ci-poem sentences, and poem or ci-poem themes before the poem or ci-poem sentences, that is, the poem or ci-poem themes may be located at the head of the poem or ci-poem corpus.

The theme refers to the central idea to be expressed in literary and artistic works or social activities, and generally refers to the main content. Specifically, in the embodiment of this disclosure, the poem or ci-poem theme can represent the central idea expressed in poem or ci-poem works. In the embodiment of this disclosure, poem or ci-poem themes are set before poem or ci-poem sentences, so that the relationship between poem or ci-poem themes and poem or ci-poem sentences can be learned into the parameters of the language model, thus enabling the language model to have the ability to generate poem or ci-poem sentences according to the poem or ci-poem themes.

In practical application, a preset character may be set between the poem or ci-poem theme and the poem or ci-poem sentence of the poem or ci-poem corpus to segment the poem or ci-poem theme and the poem or ci-poem sentence of the poem or ci-poem corpus. The preset character may include: [sep], etc. It is to be understood that the specific preset character is not limited in the embodiment of this disclosure.

To sum up, the embodiment of this disclosure obtains a language model through training according to a poem or ci-poem corpus, and can learn the rules of poems and ci-poems, such as the rules of rhymes, tonal patterns and antithesis forms of poems and ci-poems, such as five-character and seven-character poems, quatrains and metrical poems, into the parameters of the language model. In this way, the language model can follow the rules of poems or ci-poems in the process of generating poems or ci-poems, thus generating candidate poems or ci-poems that follow the rules of poems or ci-poems.

### Method Embodiment 2

Referring to FIG. 2, it illustrates a flowchart of steps of a method for generating a poem or ci-poem according to an embodiment of this disclosure. The method may specifically include the following steps:

In step 201, generation information is received.

In step 202, at least one candidate poem or ci-poem corresponding to the generation information is determined according to an autoregressive language model. The language model is obtained through training according to a poem or ci-poem corpus, and is configured to predict unknown information of a poem or ci-poem in unit of character or word according to known information of the poem or ci-poem.

The language model may include a plurality of processing layers connected sequentially. Each of the processing layers may include a self-attention module and a neural network module. The self-attention module is configured to determine attention information from a known character or word in a poem or ci-poem sentence to a character or word in a character or word list, so as to predict unknown characters or words in the poem or ci-poem sentence according to the attention information.

At least one step of the embodiment illustrated in FIG. 2 may be executed by the server and/or the client. Certainly, the specific execution subject of each step is not limited in the embodiment of this disclosure.

In step 201, the generation information may be information inputted by a user. The user may input the generation information through keyboard input, voice input and other input methods. It can be understood that the specific input method of the generation information is not limited in the embodiment of this disclosure.

The generation information may be information related to poems or ci-poems. For example, the generation information may include any one or a combination of poem or ci-poem beginning information and poem or ci-poem theme information. The poem or ci-poem beginning information may represent the beginning of a poem or ci-poem sentence. The poem or ci-poem theme information may represent the theme of a poem or ci-poem.

It can be understood that the poem or ci-poem beginning information and the poem or ci-poem theme information are only used as examples of the generation information, which cannot be understood as limitations to the generation information. In fact, the generation information may be a character or word at any position of a poem or ci-poem. In practical applications, the generation information may include characters or words of different poem or ci-poem sentences. For example, the generation information may include a character or word of a j^{th} poem or ci-poem sentence and a character or word of a k^{th} poem or ci-poem sentence. j and k may be natural numbers greater than 0, and j and k are different. For example, the generation information may include the beginning of the first poem or ci-poem sentence and a character or word at any position of any other poem or ci-poem sentence.

The position of the character or word included in the generation information in the poem or ci-poem may be specified by the user. The position of the character or word included in the generation information in the poem or ci-poem may include a poem or ci-poem sentence identity and a character or word identity. The poem or ci-poem sentence identity is used for representing the serial number of the poem or ci-poem sentence, and the character or word identity may represent the position of the character or word in the poem or ci-poem sentence.

In step 202, the generation information may be used as first-round input information of the language model, and the characters or words of the poem or ci-poem sentence may be predicted sequentially by using the autoregression mechanism of the language model, thereby generating candidate poems or ci-poems.

In the embodiment of this disclosure, the determining at least one candidate poem or ci-poem corresponding to the generation information may specifically include determining current-round input information according to the known information of the poem or ci-poem; and inputting the current-round input information into the language model to obtain a current-round prediction result.

In a specific implementation, the language model may generate and output poem or ci-poem sentences by taking poem or ci-poem sentence as granularity. Specifically, one poem or ci-poem sentence may be generated and outputted. Alternatively, the language model may generate and output a complete poem or ci-poem by taking poem or ci-poem as granularity. Specifically, all poem or ci-poem sentences of a poem or ci-poem may be generated and outputted.

Assuming that the current round is the i^{th} round and i is a natural number greater than 0, in a case that i is 1, the known information may include generation information inputted by the user; in a case that i is greater than 1, the known information may include generation information inputted by the user and a generated prediction result. In the embodiment of this disclosure, the generation information may be used as first-round input information, and the first-round input information is inputted into the language model to obtain a first-round prediction result.

For example, in a case that the generation information is poem or ci-poem beginning information [symbol] the first-round prediction result may include a character after [symbol] such as” [symbol] ”, “ [symbol] ”, “ [symbol] ”, etc.

Further, the determining at least one candidate poem or ci-poem corresponding to the generation information may further include adding the current-round prediction result after the current-round input information to obtain next-round input information; and inputting the next-round input information into the language model to obtain a next-round prediction result.

Assuming that the current round is the i^{th} round, the i^{th}-round prediction result may be added after the i^{th}-round input information to obtain (i+1)^{th}-round input information, and the (i+1)th-round input information may be inputted into the language model to obtain an (i+1)^{th}-round prediction result. By analogy, until the generation of candidate poems or ci-poems is completed, that is, after the generation of candidate poems or ci-poems is completed, the step of adding the current-round prediction result after the current-round input information may be stopped.

Since the training of the language model based on the poem or ci-poem corpus can learn the rules of poems or ci-poems into the parameters of the language model, the language model can determine the completion of the generation of candidate poems or ci-poems after the candidate poems or ci-poems that follows the rules of poems or ci-poems are generated.

In the embodiment of this disclosure, the current-round prediction result may specifically include at least one character or word with attention information satisfying a preset condition. Different characters or words may correspond to different current-round prediction results.

For example, in a case that the attention information corresponding to the character or word in the character or word list is attention score, characters or words as the prediction result may be determined from the character or word list according to the order of attention scores from high to low. For example, N characters or words with high attention scores may be selected as a current-round prediction result.

In the embodiment of this disclosure, the language model may correspond to at least one format parameter, and the language model may be configured to generate at least one candidate poem or ci-poem conforming to the at least one format parameter.

For example, the format parameter may include at least one of sentence number parameter, character number parameter of characters contained in each sentence, and the like.

In an embodiment of this disclosure, the language model may generate a plurality of candidate poems or ci-poems conforming to a variety of format parameters. For example, five-character metrical poems with a character number parameter of 5 are generated, seven-character metrical poems with a character number parameter of 7 are generated, five-character quatrains with a character number parameter of 5 are generated, seven-character quatrains with a character number parameter of 7 are generated, etc.

It is to be understood that the embodiment of this disclosure can combine different options of different format parameters to obtain a plurality of combination results, and generate corresponding candidate poems or ci-poems for the plurality of combination results. For example, the combination results may include “five-character”+“metrical poem”, “five-character”+“quatrain”, “seven-character”+“metrical poem”, “seven-character”+“quatrain”, etc.

In another embodiment of this disclosure, at least two format parameter options can be provided, so the determining at least one candidate poem or ci-poem corresponding to the generation information specifically includes determining at least one candidate poem or ci-poem corresponding to the generation information according to a target format parameter option selected by the user.

In a specific implementation, at least two format parameter options corresponding to one format parameter may be provided. Alternatively, at least two format parameter options corresponding to a plurality of format parameters respectively may be provided. In this case, different options selected by the user may be combined, and corresponding candidate poems or ci-poems may be generated according to the combination results.

For example, “metrical poem” and “quatrain” options are provided for the sentence number parameter, and the “five -character” and “seven-character” options are provided for the character number parameter. Then, in a case that the user selects “metrical poem” and “five-character”, at least one candidate poem or ci-poem corresponding to “five-character”+“metrical poem” may be generated.

It is to be understood that for a combination result, since the current-round prediction result may include N characters or words in the process of generating corresponding poems or ci-poems, the corresponding poem or ci-poem generation result may include N candidate poems or ci-poems.

In the embodiment of this disclosure, at least one candidate poem or ci-poem may be displayed for the user to view and use. For example, the user may copy and share the displayed candidate poems or ci-poems.

To sum up, the method for generating a poem or ci-poem provided by the embodiment of this disclosure obtains a language model through training according to a poem or ci-poem corpus, and can learn the rules of poems and ci-poems, such as the rules of rhymes, tonal patterns and antithesis forms of poems and ci-poems, such as five-character and seven-character poems, quatrains and metrical poems, into the parameters of the language model. In this way, the language model can follow the rules of poems or ci-poems in the process of generating poems or ci-poems, thus generating candidate poems or ci-poems that follow the rules of poems or ci-poems.

In addition, the language model in the embodiments of this disclosure adopts an autoregression mechanism, which can update the input information according to a real-time prediction result, so that a text with a preset length can be generated iteratively.

Besides, the self-attention module of the language model in the embodiments of this disclosure can quickly capture the dependency between each known character or word and the character or word in the character or word list, so it can take the characters or words with strong dependency as a prediction result, thus improving the consistency of the generated candidate poems or ci-poems.

In order to enable those skilled in the art to better understand the embodiments of this disclosure, specific application examples of the method for generating a poem or ci-poem provided by the embodiment of this disclosure will be provided below.

### Application Example 1

In application example 1, in the training process of the language model, the poem or ci-poem corpus may include poem or ci-poem sentences. In this way, the rules of poems or ci-poems can be learned into the parameters of the language model.

In the process of generating a poem or ci-poem according to the language model, the generation information inputted by the user may include poem or ci-poem beginning information, such as at least one character or word at the beginning of a poem, so that the embodiment of this disclosure may make an autoregressive prediction according to the poem or ci-poem beginning information, thereby obtaining at least one corresponding candidate poem or ci-poem.

For example, in a case that the poem or ci-poem beginning information is [symbol] , the embodiment of this disclosure may generate at least one candidate poem or ci-poem beginning with [symbol] and display it to the user.

### Application Example 2

In application example 2, in the training process of the language model, the poem or ci-poem corpus may include poem or ci-poem sentences and poem or ci-poem themes before the poem or ci-poem sentences. Poem or ci-poem themes are set before poem or ci-poem sentences, so that the relationship between poem or ci-poem themes and poem or ci-poem sentences can be learned into the parameters of the language model, thus enabling the language model to have the ability to generate poem or ci-poem sentences according to poem or ci-poem themes.

In the process of generating a poem or ci-poem according to the language model, the generation information inputted by the user may include poem or ci-poem theme information, so that the embodiment of this disclosure may make an autoregressive prediction according to the poem or ci-poem theme information, thereby obtaining at least one corresponding candidate poem or ci-poem.

For example, in a case that the poem or ci-poem theme information is “ [symbol] ”, the embodiment of this disclosure may generate at least one candidate poem or ci-poem with “ [symbol] ” as the theme and display it to the user.

It is to be understood that, the foregoing method embodiments are expressed as a series of action combinations for the purpose of brief description, but those skilled in the art know that because some steps may be performed in other sequences or simultaneously according to the embodiments of this disclosure, the embodiments of this disclosure are not limited to a described action sequence. In addition, those skilled in the art also know that the embodiments described in the description are some exemplary embodiments and the actions involved are not necessarily mandatory in the embodiments of this disclosure.

### Apparatus Embodiment

Referring to FIG. 3, it illustrates a structural block diagram of an apparatus for generating a poem or ci-poem according to an embodiment of this disclosure. The apparatus may specifically include a receiving module 301 and a candidate poem or ci-poem determination module 302. One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The receiving module 301 is configured to receive generation information.

The candidate poem or ci-poem determination module 302 is configured to determine at least one candidate poem or ci-poem corresponding to the generation information according to an autoregressive language model. The language model is obtained through training according to a poem or ci-poem corpus, and is configured to predict unknown information of a poem or ci-poem in unit of character or word according to known information of the poem or ci-poem.

The language model may include a plurality of processing layers connected sequentially. Each of the processing layers may include a self-attention module and a neural network module. The self-attention module is configured to determine attention information from a known character or word in a poem or ci-poem sentence to a character or word in a character or word list, so as to predict unknown characters or words in the poem or ci-poem sentence according to the attention information.

In some examples, the generation information may include:
poem or ci-poem beginning information; and/or
poem or ci-poem theme information.

In some examples, in a case that the generation information may include poem or ci-poem theme information, the poem or ci-poem corpus may include poem or ci-poem sentences and poem or ci-poem themes before the poem or ci-poem sentences.

In some examples, the language model corresponds to at least one format parameter, and the language model is configured to generate at least one candidate poem or ci-poem conforming to the at least one format parameter.

In some examples, the apparatus may further include:

a providing module, configured to provide at least two format parameter options.

The candidate poem or ci-poem determination module may include:

a first candidate poem or ci-poem determination module, configured to determine at least one candidate poem or ci-poem corresponding to the generation information according to a target format parameter option selected by a user.

In some examples, the candidate poem or ci-poem determination module may include:
a first input information determination module, configured to determine current-round input information according to the known information of the poem or ci-poem; and
a first input module, configured to input the current-round input information into the language model to obtain a current-round prediction result.

In some examples, the candidate poem or ci-poem determination module may further include:
a second input information determination module, configured to add the current-round prediction result after the current-round input information to obtain next-round input information; and
a second input module, configured to input the next-round input information into the language model to obtain a next-round prediction result.

In some examples, the current-round prediction result may include at least one character or word with attention information satisfying a preset condition.

An apparatus embodiment may be similar to a method embodiment, and therefore is described briefly. For related parts, refer to partial descriptions in the method embodiment.

The embodiments in this description are all described in a progressive manner. Description of each of the embodiments focuses on differences from other embodiments, and reference may be made to each other for the same or similar parts among respective embodiments.

The specific manners of performing operations by the various modules of the apparatuses in the foregoing embodiments are described in detail in the embodiments related to the methods, and are not further described in detail herein.

The embodiment of this disclosure provides a device for generating a poem or ci-poem, which includes a memory and one or more programs. The one or more programs are stored in the memory and it is configured that one or more processors execute instructions contained in the one or more programs for performing the following operations: receiving generation information; and determining at least one candidate poem or ci-poem corresponding to the generation information according to an autoregressive language model. The language model is obtained through training according to a poem or ci-poem corpus, and is configured to predict unknown information of a poem or ci-poem in unit of character or word according to known information of the poem or ci-poem. The language model includes a plurality of processing layers connected sequentially. Each of the processing layers includes a self-attention module and a neural network module. The self-attention module is configured to determine attention information from a known character or word in a poem or ci-poem sentence to a character or word in a character or word list, so as to predict unknown characters or words in the poem or ci-poem sentence according to the attention information.

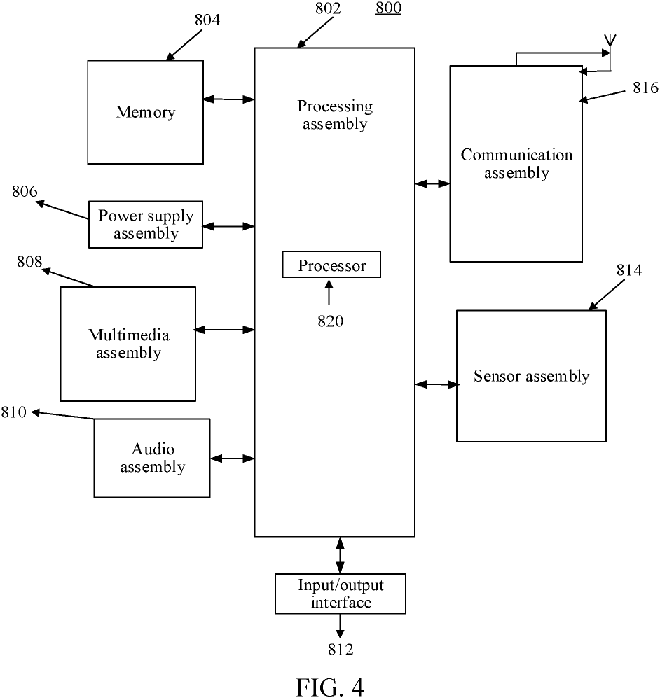

FIG. 4 is a block diagram of a device 800 for generating a poem or ci-poem according to an exemplary embodiment. For example, the device 800 may be a mobile phone, a computer, a digital broadcasting terminal, a messaging device, a game console, a tablet device, a medical device, a fitness facility, a personal digital assistant, or the like.

Referring to FIG. 4, the device 800 may include one or more of the following assemblies: a processing assembly (or processing circuitry) 802, a memory 804, a power supply assembly 806, a multimedia assembly 808, an audio assembly 810, an input/output (I/O) interface 812, a sensor assembly 814, and a communication assembly 816.

The processing assembly 802 usually controls the whole operation of the device 800, such as operations associated with displaying, a phone call, data communication, a camera operation, and a recording operation. The processing assembly 802 may include one or more processors 820 to execute instructions, to complete all or some steps of the foregoing method. In addition, the processing assembly 802 may include one or more modules, to facilitate the interaction between the processing assembly 802 and other assemblies. For example, the processing assembly 802 may include a multimedia module, to facilitate the interaction between the multimedia assembly 808 and the processing assembly 802.

The memory 804 is configured to store various types of data to support operations on the device 800. Examples of the data include instructions, contact data, phonebook data, messages, pictures, videos, and the like of any application or method used to be operated on the device 800. The memory 804 can be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disc, or an optical disc.

The power supply assembly 806 provides power to various assemblies of the device 800. The power supply assembly 806 may include a power supply management system, one or more power supplies, and other assemblies associated with generating, managing and allocating power for the device 800.

The multimedia assembly 808 includes a screen providing an output interface between the device 800 and a user. In some embodiments, the screen may include a liquid crystal display (LCD) and a touch panel (TP). If the screen includes a TP, the screen may be implemented as a touchscreen, to receive an input signal from the user. The TP includes one or more touch sensors to sense touching, sliding, and gestures on the TP. The touch sensor may not only sense the boundary of touching or sliding operations, but also detect duration and pressure related to the touching or sliding operations. In some embodiments, the multimedia assembly 808 includes a front camera and/or a rear camera. When the device 800 is in an operation mode, such as a shoot mode or a video mode, the front camera and/or the rear camera may receive external multimedia data. Each front camera and rear camera may be a fixed optical lens system or have a focal length and an optical zooming capability.

The audio assembly 810 is configured to output and/or input an audio signal. For example, the audio assembly 810 includes a microphone (MIC), and when the device 800 is in an operation mode, such as a call mode, a recording mode, and a voice data processing mode, the MIC is configured to receive an external audio signal. The received audio signal may be further stored in the memory 804 or sent through the communication assembly 816. In some embodiments, the audio assembly 810 further includes a loudspeaker, configured to output an audio signal.

The I/O interface 812 provides an interface between the processing assembly 802 and an external interface module. The external interface module may be a keyboard, a click wheel, buttons, or the like. The buttons may include, but not limited to: a homepage button, a volume button, a start-up button, and a locking button.

The sensor assembly 814 includes one or more sensors, configured to provide status evaluation in each aspect to the device 800. For example, the sensor assembly 814 may detect an on/off state of the device 800, and relative positioning of the assembly. For example, the assembly is a display and a small keyboard of the device 800. The sensor assembly 814 may further detect the position change of the device 800 or one assembly of the device 800, the existence or nonexistence of contact between the user and the device 800, the azimuth or acceleration/deceleration of the device 800, and the temperature change of the device 800. The sensor assembly 814 may include a proximity sensor, configured to detect the existence of nearby objects without any physical contact. The sensor assembly 814 may further include an optical sensor, such as a CMOS or CCD image sensor, that is used in an imaging application. In some embodiments, the sensor assembly 814 may further include an acceleration sensor, a gyroscope sensor, a magnetic sensor, a pressure sensor, or a temperature sensor.

The communication assembly (or communication circuitry) 816 is configured to facilitate communication in a wired or wireless manner between the device 800 and other devices. The device 800 may access a wireless network based on communication standards, such as Wi-Fi, 2G, or 3G, or a combination thereof. In an exemplary embodiment, the communication assembly 816 receives a broadcast signal or broadcast related information from an external broadcast management system via a broadcast channel. In an exemplary embodiment, the communication assembly 816 further includes a near field communication (NFC) module, to promote short range communication. For example, the NFC module may be implemented based on a radio frequency identification (RFID) technology, an infra-red data association (IrDA) technology, an ultra wideband (UWB) technology, a Bluetooth (BT) technology, and other technologies.

In an exemplary embodiment, the device 800 may be implemented as one or more processing circuitry, such as application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic elements, so as to perform the method.

In an exemplary embodiment, a non-transitory computer-readable storage medium including instructions, for example, a memory 804 including instructions, is further provided, and the foregoing instructions may be executed by a processor 820 of the device 800 to complete the method. For example, the non-transitory computer-readable storage medium may be an ROM, a random access memory (RAM), a CD-ROM, a magnetic tape, a floppy disk, an optical data storage device, or the like.

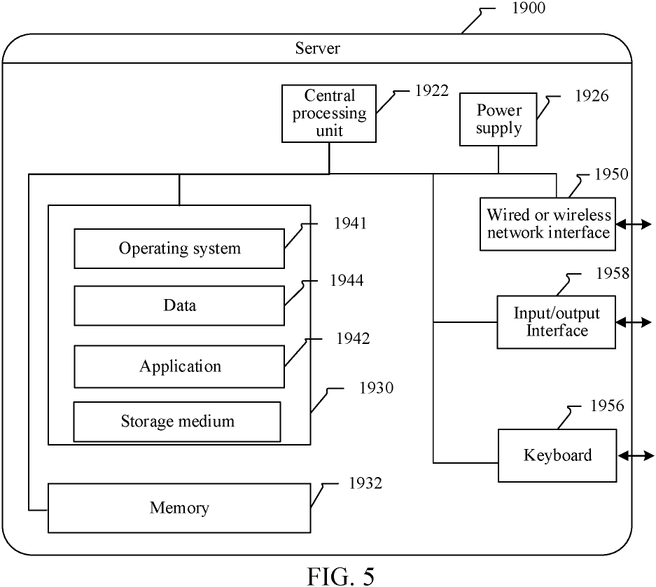

FIG. 5 is a schematic structural diagram of a server according to an embodiment of this disclosure. The server 1900 may vary greatly due to different configurations or performance, and may include one or more central processing units (CPUs) 1922 (for example, one or more processors or processing circuitry) and a memory 1932, and one or more storage media 1930 (for example, one or more mass storage devices) that store application programs 1942 or data 1944. The memory 1932 and the storage media 1930 may be used for transient storage or permanent storage. A program stored in the storage medium 1930 may include one or more modules (not shown), and each module may include a series of instruction operations on the server. Still further, the CPU 1922 may be set to communicate with the storage medium 1930, and perform, on the server 1900, the series of instruction operations in the storage medium 1930.

The server 1900 may further include one or more power supplies 1926, one or more wired or wireless network interfaces 1950, one or more input/output interfaces 1958, one or more keyboards 1956, and/or one or more operating systems 1941, for example, Windows Server™, Mac OS _{X}™ Unix™, Linux™, and FreeBSD™.

A non-transitory computer-readable storage medium is provided. When the instructions in the storage medium are executed by the processor of the apparatus (server or terminal), the apparatus is enabled to execute the method for generating a poem or ci-poem illustrated in FIG. 2, FIG. 3 or FIG. 4.

A non-transitory computer-readable storage medium is provided. When the instructions in the storage medium are executed by the processor of the apparatus (server or terminal), the apparatus is enabled to execute a method for generating a poem or ci-poem, which includes: receiving generation information; and determining at least one candidate poem or ci-poem corresponding to the generation information according to an autoregressive language model. The language model is obtained through training according to a poem or ci-poem corpus, and is configured to predict unknown information of a poem or ci-poem in unit of character or word according to known information of the poem or ci-poem. The language model includes a plurality of processing layers connected sequentially. Each of the processing layers includes a self-attention module and a neural network module. The self-attention module is configured to determine attention information from a known character or word in a poem or ci-poem sentence to a character or word in a character or word list, so as to predict unknown characters or words in the poem or ci-poem sentence according to the attention information.

After considering the description and implementing the present disclosure, those skilled in the art can readily think of other implementations of this disclosure. This disclosure is intended to cover any variation, use, or adaptive change of this disclosure. These variations, uses, or adaptive changes follow the general principles of this disclosure and include common general knowledge or common technical means, which are not disclosed in the present disclosure, in the art. The specification and the embodiments are considered as merely exemplary, and the real scope and spirit of this disclosure are pointed out in the following claims.

It is to be understood that this disclosure is not limited to the precise structures described above and shown in the accompanying drawings, and various modifications and changes can be made without departing from the scope of this disclosure.

The foregoing descriptions are merely exemplary embodiments of this disclosure, but are not intended to limit this disclosure. Any modification, equivalent replacement, or improvement made within the spirit and principle of this disclosure shall fall within the protection scope of this disclosure.

A method for generating a poem or ci-poem, an apparatus for generating a poem or ci-poem and a device for generating a poem or ci-poem in the embodiments of this disclosure are described in detail above. Examples of the principle and implementations of this disclosure are described herein by using specific examples. The descriptions of the foregoing embodiments are merely used for helping understand the this disclosure. In addition, those skilled in the art can make variations to this disclosure in terms of the specific implementations and disclosure scope according to the ideas of this disclosure. Therefore, the content of this description shall not be construed as a limitation to this disclosure.

What is claimed is:

1. A method for poetry generation, the method comprising:
receiving generation information indicative of a theme for the poetry generation; and
determining, by processing circuitry, at least a candidate piece of poetry corresponding to the generation information according to an autoregressive language model, the autoregressive language model being configured to generate elements in the candidate piece of poetry in an autoregressive manner with a plurality of regression rounds, an element in the elements being a character or a word, wherein:
the autoregressive language model is configured to generate poetry in a plurality of formats, the autoregressive language model including a plurality of processing layers connected sequentially,
a processing layer in the plurality of processing layers is configured to determine attention levels for potential elements in a potential element list according to generated elements prior to a current regression round, and predict one or more additional elements for the current regression round using a neural network according to the attention levels.

2. The method according to claim 1, wherein the generation information comprises:
a beginning element for the poetry generation ; and/or
the theme for the poetry generation.

3. The method according to claim 1, wherein the autoregressive language model is trained based on a poetry corpus, the poetry corpus comprises:
one or more sample pieces of poetry; and/or
one or more sample pieces of poetry with respective themes.

4. The method according to claim 1, wherein the autoregressive language model is configured to generate a plurality of candidate pieces of poetry conforming to the plurality of formats.

5. The method according to claim 1, further comprising:
providing at least a first option of a format parameter and a second option of the format parameter;
determining a target format according to a selection from at least the first option and the second option by a user; and
determining the at least the candidate piece of poetry in the target format based on the autoregressive language model.

6. The method according to claim 1, wherein the determining the at least the candidate piece of poetry further comprises:
determining a first candidate piece of poetry and a second candidate piece of poetry corresponding to the generation information according to the autoregressive language model, the first candidate piece of poetry being in a first format and the second candidate piece being in a second format.

7. The method according to claim 1, wherein the determining the at least the candidate piece of poetry comprises:
determining first inputs for the current regression round according to the generated elements prior to the current regression round; and
inputting the first inputs into the autoregressive language model to obtain a first prediction result of the current regression round from the autoregressive language model.

8. The method according to claim 7, wherein the determining the at least the candidate piece of poetry further comprises:
adding the first prediction result of the current regression round with the first inputs to obtain second inputs for a next regression round after the current regression round; and
inputting the second inputs into the autoregressive language model to obtain a second prediction result of the next regression round from the autoregressive language model.

9. The method according to claim 7, wherein the first prediction result comprises at least one predicted element with an attention level satisfying a preset condition.

10. The method according to claim 7, further comprising:
ranking the potential elements in an order according to the attention levels; and
selecting one or more top ranking potential elements according to the order as the first prediction result.

11. An apparatus for poetry generation, comprising processing circuitry configured to:
receive generation information indicative of a theme for the poetry generation; and
determine at least a candidate piece of poetry corresponding to the generation information according to an autoregressive language model, the autoregressive language model being configured to generate elements in the candidate piece of poetry in an autoregressive manner with a plurality of regression rounds, an element in the elements being a character or a word, wherein:
the autoregressive language model is configured to generate poetry in a plurality of formats, the autoregressive language model includes a plurality of processing layers connected sequentially, a processing layer in the plurality of processing layers is configured to determine attention levels for potential elements in a potential element list according to generated elements prior to a current regression round, and predict one or more additional elements for the current regression round using a neural network according to the attention levels.

12. The apparatus according to claim 11, wherein the generation information comprises:
a beginning element for the poetry generation; and/or
the theme for the poetry generation.

13. The apparatus according to claim 11, wherein the autoregressive language model is trained based on a poetry corpus, the poetry corpus comprises:
one or more sample pieces of poetry; and/or
one or more sample pieces of poetry with respective themes.

14. The apparatus according to claim 11, wherein the autoregressive language model is configured to generate a plurality of candidate pieces of poetry conforming to the plurality of formats.

15. The apparatus according to claim 11, wherein the processing circuitry is configured to:
provide at least a first option of a format parameter and a second option of the format parameter;
determine a target format according to a selection from at least the first option and the second option by a user; and
determine the at least the candidate piece of poetry in the target format based on the autoregressive language model.

16. The apparatus according to claim 11, wherein the processing circuitry is configured to:
determine a first candidate piece of poetry and a second candidate piece of poetry corresponding to the generation information according to the autoregressive language model, the first candidate piece of poetry being in a first format and the second candidate piece being in a second format.

17. The apparatus according to claim 11, wherein the processing circuitry is configured to:
determine first inputs for the current regression round according to the generated elements prior to the current regression round; and
input the first inputs into the autoregressive language model to obtain a first prediction result of the current regression round from the autoregressive language model.

18. The apparatus according to claim 17, wherein the processing circuitry is configured to:
add the first prediction result of the current regression round with the first inputs to obtain second inputs for a next regression round after the current regression round; and
input the second inputs into the autoregressive language model to obtain a second prediction result of the next regression round from the autoregressive language model.

19. The apparatus according to claim 17, wherein the first prediction result comprises at least one predicted element with an attention level satisfying a preset condition.

20. The apparatus according to claim 17, wherein the processing circuitry is configured to:
rank the potential elements in an order according to the attention levels; and
select one or more top ranking potential elements according to the order as the first prediction result.
